(19) United States
(12) Patent Application Publication
(10) Pub. No.: US 2003/0197494 A1
(43) Pub. Date: Oct. 23, 2003

(54) DC-DC converter and a method of controlling thereof

(75) Inventors: Akihiko Kanouda, Hitachinaka (JP); Kenichi Onda, Takasaki (JP); Norikazu Tokunaga, Hitachi (JP); Ryouhei Saga, Takasaki (JP); Kyoichi Hosokawa, Takasaki (JP)

Correspondence Address: CROWELL & MORING, LLP, Intellectual Property Dept., P.O. Box 14300, Washington, DC, 20044-4300, US

(73) Assignee: Hitachi, Ltd.

(21) Appl. No.: 10/427,910

(22) Filed: May 2, 2003

Related U.S. Application Data
(63) Continuation of application No. 10/059,363, filed on Jan. 31, 2002.

(30) Foreign Application Priority Data
Jun. 7, 2001 (JP) 2001-171913

(51) Int. Cl. G05F 1/40

(52) U.S. Cl. 323/287

(57) ABSTRACT

A DC-DC converter of low ripple voltages which has a bi-directional power conversion means between an input power source and a smoothing capacitor and can quickly change the output voltage independently of the load. Said DC-DC converter comprises a main circuit of a non-insulated step-down DC-DC converter comprising at least two semiconductor elements, a DC reactor, and a smoothing capacitor, means for generating a variable reference voltage, means for comparing a reference voltage generated by said reference voltage generating means by the output voltage and outputting differential voltage information, means for generating a signal to be applied to the control terminals of said semiconductor element according to said differential voltage information, and means for discriminating the direction of a current flowing through said DC reactor.

### BACKGROUND OF THE INVENTION

1. Field of the Invention

The present invention relates to a DC-DC converter which converts an input from a DC power source into a preset DC output voltage and supplies it to an integrated circuit.

2. Prior Art

Recently, battery-operated cellular phones and mobile units have been made to have higher performance and their central processing units have been required to have higher processing abilities. Naturally, their batteries have been required to work longer. Particularly, to reduce power consumption, their supply voltages have a tendency to be lower. Consequently, mobile units have been required to have a power supply unit of higher conversion efficiency.

Typical conventional power supply units for mobile units are series regulators and DC-DC converting units (hereinafter called DC-DC converters). Judging from conversion efficiency, the DC-DC converters are more advantageous in low voltages than the series regulators as the series regulator generates a loss which is determined by the product of a load current by a difference between supply and output voltages. However, the DC-DC converters have fluctuations (ripples) on the output voltages due to their operation principle.

FIG. 2 shows the block diagram of a basic step-down chopper type DC-DC converter. This block diagram comprises a DC power source 1, a P-channel power MOS field effect transistor (MOSFET) 2, a feedback diode 3, a DC reactor 4, a smoothing capacitor 5, a load 6, an output feedback circuit 7, and a switching control circuit 9.

Blow will be explained the operation of the power source 1 of FIG. 2. The output voltage feedback circuit 7 inputs a voltage of the smoothing capacitor 5, calculates the difference between the voltage and a preset output reference voltage, and amplifies it. The output of the output feedback circuit 7 is fed to the switching control circuit 9, converted into a pulse train there, and modulated by the P-channel power MOSFET 2 (by a pulse width modulation PWM). With this, the DC reactor 4 repeats storage and discharge of energy which is excited by current. This induces a voltage fluctuation. The voltage fluctuation appears as a ripple voltage on the output. When a DC-DC converter uses a lower supply voltage, it requires a more strict control standard to suppress ripple voltages for assurance of steady operation of the unit. To suppress the ripple voltages, there have been well-known a method of increasing the capacitance of the smoothing capacitor 5 and a method of shortening the on/off cycle of said P-channel power MOSFET.

Japanese Application Patent Laid-Open Publication No. Hei 08-242577 discloses a method of connecting a plurality of regulator circuits in parallel, respectively controlling their operation with their switching phases shifted, and combining their outputs to suppress the ripple voltage.

Additionally, a new type of CPU equipped with a power optimizing function has been put to practical use. This has been introduced, for example, by “Crusoe Shipping,” Nikkei Electronics (Mar. 13, 2000). This power optimizing function is a means to control a supply voltage and an operating frequency according to the load of the CPU. This function increases the supply voltage to increase the operating frequency when a high processing ability is required or decrease the supply voltage to decrease the operating frequency when a high processing ability is not required. This control is repeated finely (several hundreds per second) to suppress power consumption. The power supply units for mobile units in the future are required to supply variable voltages to such CPUs.

Generally, the method of increasing the capacitance of the smoothing capacitor 5 uses comparatively big and expensive capacitors of large capacitances. This prevents reduction of size and cost of the mobile units. The method of shortening the on/off cycle of said P-channel power MOSFET, that is, a method of increasing a switching frequency requires higher switching frequency, but the switching speed of the switching element is limited.

The above method of connecting a plurality of regulator circuits in parallel requires more regulator circuits to decrease the ripple voltage. Each regulator circuit comprises a power transistor, a driving circuit, a DC smoothing series circuit, a smoothing capacitor, and a feedback diode. Therefore, when a power supply unit has more regulator circuits, the whole power supply unit will have much more components. This also prevents reduction of size and cost of the mobile units.

Further, a smoothing capacitor of a large capacitance for the above CPU has a problem, that is, such a capacitor is slow to change the output voltage. To change voltages rapidly, a greater current is required to charge or discharge. Particularly, to decrease the voltage, the charge stored in the capacitor must be discharged. However, if the load is small, the capacitor is slow to discharge the charge and the output voltage cannot go down. Further, a large current will cause a great loss if the capacitor has a high impedance.

### SUMMARY OF THE INVENTION

An object of the present invention to provide a power supply unit using a low-impedance large-capacitance smoothing capacitor such as an electric double layer capacitor that can control the output voltage having a very low ripple voltage independently of a load.

The DC-DC converter in accordance with the present invention contains a main circuit of a non-insulating step-down DC-DC converter which comprises at least two semiconductor elements, a DC reactor, and a smoothing capacitor. The DC-DC converter further comprises a reference voltage generating means which can vary the setting of the reference voltage, a means of comparing the output voltage by a reference voltage which is generated by said reference voltage generating means and outputting error information, a means of generating a signal to be applied to the control terminal of said semiconductor element according to said error information, and a means of discriminates the orientation of a current flowing through said DC reactor.

The DC-DC converter of the present invention varies the reference voltage value of said reference voltage generating means according to the variable supply voltage controlling, generates a signal to be applied to the control terminal of the semiconductor element according to information about a difference between the output voltage and the reference voltage, and thus obtains a desired output voltage. When decrementing the output voltage, the DC-DC converter discriminates the orientation of a current flowing through the DC reactor, varies a signal applied to the control terminal of said semiconductor element, forms a route to discharge a charge which is stored on said smoothing capacitor, and thus reduces the output voltage immediately to the preset voltage value.

The route to discharge a charge stored on said smoothing capacitor in the DC-DC converter of the present invention can be a circuit in the DC-DC converter or added to the DC-DC converter. It is possible to use the stored charge effectively by feeding said stored charge to a rechargeable battery.

### BRIEF DESCRIPTION OF THE DRAWINGS

FIG. 1 is the basic configuration of a DC-DC converter which is the first embodiment of the present invention;

FIG. 2 is the basic configuration of a conventional DC-DC converter;

FIG. 3 shows signal waveforms indicating the operation of the circuit of Embodiment 1 in the steady status;

FIG. 4 shows signal waveforms when the output voltage of Embodiment 1 is increased;

FIG. 5 shows signal waveforms when the output voltage of Embodiment 1 is decreased;

FIG. 6 shows signal waveforms when the output voltage of Embodiment 2 is decreased;

FIG. 7 shows signal waveforms when the output voltage of Embodiment 3 is decreased;

FIG. 8 shows signal waveforms when the output voltage of Embodiment 3 is increased by another control method;

FIG. 9 is the basic configuration of a DC-DC converter which is the second embodiment of the present invention;

FIG. 10 is the basic configuration of a DC-DC converter which is the fourth embodiment of the present invention; and

FIG. 11 is the basic configuration of a DC-DC converter which is the fifth embodiment of the present invention.

### DESCRIPTION OF THE INVENTION

This invention will be described in further detail by way of embodiments with reference to the accompanying drawings.

(Embodiment 1)

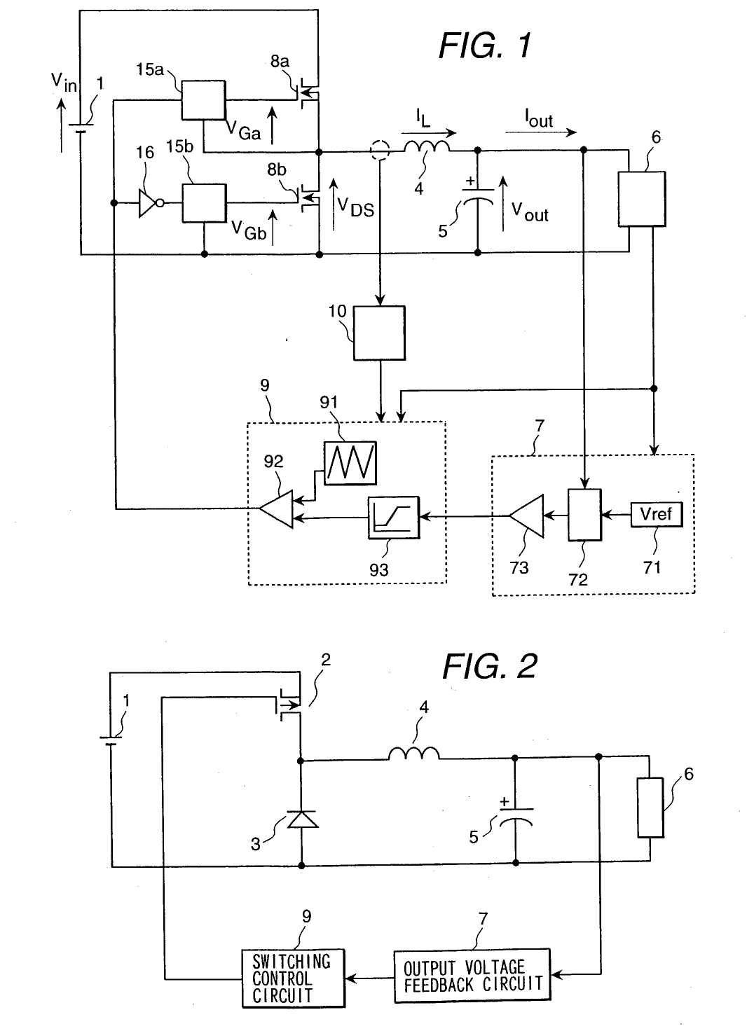

FIG. 1 is a basic configuration of a step-down chopper type synchronous rectification DC-DC converter which is an embodiment of the present invention. The converter in FIG. 1 comprises a DC power source 1, a DC reactor 4, a smoothing capacitor 5, a load 7, an output voltage feedback circuit 7, N-channel power MOS field effect transistors 8a and 8b, a switching control circuit 9, a current orientation discriminating circuit 10 for discriminating the orientation of a current flowing through the DC reactor 4, driving circuits 15a and 15b, an inversion circuit 16, a reference voltage circuit 71, an error operation circuit 72, an error amplifier, a triangular wave generating means 91, a comparator 92, and a limiter 93. The smoothing capacitor 5 is a low-impedance large-capacitance smoothing capacitor such as an electric double layer capacitor. Generally, the electric double layer capacitor can offer a large capacitance in farads (F). It is re-chargeable and has a long service life. Its impedance is very low as disclosed by Japanese Application Patent Laid-Open Publication No. Hei 06-242577 and Hei 11-154630. Generally the load 6 is an integrated circuit, for example, a CPU having the aforesaid power optimizing function.

Referring to FIG. 1, the anode of the DC power source 1 is connected to the drain of the N-channel power MOS field effect transistor (MOSFET) 8a. The source of the N-channel power MOSFET 8a is connected to one terminal of the DC reactor 4 and to the drain of the other N-channel power MOSFET 8b. The other terminal of the DC reactor 4 is connected to the anode of the smoothing capacitor 5. The cathode of the smoothing capacitor 5, the source of the N-channel power MOSFET 8b, and the cathode of the DC power source are connected together. A load 6 is connected to both ends of the smoothing capacitor 5.

The anode of the smoothing capacitor 5 is connected to the error operation circuit 72 in the output feedback circuit 7. The reference voltage circuit 71 is also connected to the error operation circuit 72. The load 6 can control the voltage setting of the reference voltage circuit 71 to change the output voltage. (The circuit operation for this voltage setting will be described later.) The output of the error operation circuit 72 is connected to the input of the error amplifier 73 and the output of the error amplifier 73 is connected as an output of the output feedback circuit 7 to the limiter 93 in the switching control circuit 9. The output of the limiter 93 is connected to one of the inputs of the comparator 92 and the output of the triangular wave generating means is connected to the other input of the comparator 92. The output of the comparator is output as an output of the switching control circuit 9 to the driving circuit 15a and to the inversion circuit 16. The output of the inversion circuit 16 is connected to the driving circuit 15b. The output of the driving circuit 15a is connected to the gate of the N-channel power MOSFET 8a and the output of the driving circuit 15b is connected to the gate of the N-channel power MOSFET 8b. The output of the current orientation discriminating circuit 10 for discriminating the orientation of a current flowing through the DC reactor 4 is connected to the switching control circuit 9.

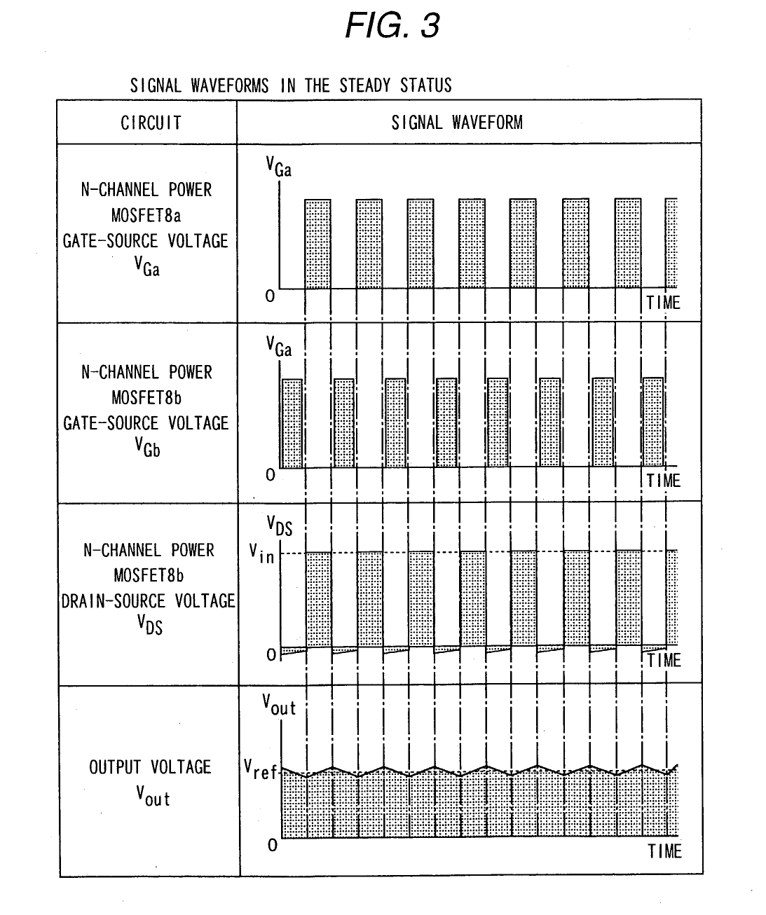

Below will be explained the operation of this embodiment in the steady status in which the reference voltage is preset to a voltage value of V_{ref}. FIG. 3 shows signal waveforms indicating the operation of the circuit of FIG. 1 in the steady status. The explanation below assumes the switching control circuit 9 performs a PWM control. Referring to FIG. 1, the output voltage Vₒᵤₜ across the smoothing capacitor 5 is applied to the output feedback circuit 7. The difference between the voltage Vₒᵤₜ and the reference voltage 71 is output from the error operation circuit 72. The error amplifier 73 amplifies this error voltage and outputs the amplified voltage as an output of the output feedback circuit 7. This amplified error voltage is fed to the limiter 93 in the switching control circuit 9. The limiter 93 limits the maximum and minimum PWM ratios. The amplified error voltage is fed into the comparator 92 through the limiter 93.

The comparator 92 compares the output from the limiter 93 by the output from the triangular wave generating means 91 and outputs a resulting pulse train to the driving circuit 15a. The driving circuit 15a applies a gate-source voltage pulse V_{Ga} (see FIG. 3) between the gate and the source of the N-channel power MOSFET 8a. The peak value of the pulse train is fully higher than the threshold voltage of the N-channel power MOSFET 8a. This pulse train causes the N-channel power MOSFET to switch. The output of the comparator 92 is connected to the input of the inversion circuit 16. The inversion circuit 16 receives a pulse train from the comparator 92, inverts the pulse train, and feeds it to the driving circuit 15b. The driving circuit 15b applies a gate-source voltage pulse V_{Gb} (see FIG. 3) between the gate and the source of the N-channel power MOSFET 8b.

When the gate-source voltage is applied to the N-channel power MOSFET 8a, the N-channel power MOSFET 8a turns on and the N-channel power MOSFET 8b turns off. This connects the DC power source 1, the DC reactor 4, and the smoothing capacitor 5 in series. As the result, a current I_{L} flows in the DC reactor 4. When the N-channel power MOSFET 8a turns on and the N-channel power MOSFET 8b turns off, the current I_{L} in the DC reactor increases at a rate of dIᵢₙ/dt.

dI_{L}/dt=(Vᵢₙ−Vₒᵤₜ)/L (1)

wherein L represents the induction reactance of the DC reactor 4. The direction of the current I_{L} is positive when the current flows from the DC reactor 4 to the load 6. The current I_{L} flowing through the DC reactor 4 charges the smoothing capacitor 5. In this case, the voltage V_{DS} across the N-channel power MOSFET 8b is approximately equal to the input voltage Vᵢₙ.

When the voltage between the gate and the source of the N-channel power MOSFET 8a reaches 0, the N-channel power MOSFET 8a goes off. At the same time, N-channel power MOSFET 8b turns on to make up for it. The current I_{L} flowing in the DC reactor 4 synchronously rectified so that the current may flow from the source to the drain of the N-channel power MOSFET 8b. In this case, the current I_{L} flowing through the DC reactor 4 is expressed by

dI_{L}/dt=−(Vₒᵤₜ)/L (2)

The current I_{L} flowing through the DC reactor 4 decrements at a rate given by the equation (2). In this case, the voltage V_{DS} of the drain of the N-channel power MOSFET 8b is an on-voltage component of the N-channel power MOSFET 8b below 0V, that is, a negative voltage equal to the product of the ON resistance by the magnitude of the flowing current. As the result, the voltage V_{DS} across the N-channel power MOSFET 8b generates a waveform shown in FIG. 3. The DC reactor 4 and the smoothing capacitor 5 smooth the voltage waveform of the N-channel power MOSFET 8b. This control system works to keep the output voltage Vₒᵤₜ constant and to assure the output current Iₒᵤₜ. The above operation in the steady status is the basic operation of the step-down chopper type synchronous rectification DC-DC converter.

Next will be explained how the circuit of this embodiment works to change the output voltage. To change the output voltage, this embodiment sends a setting signal from the load 6 to the output feedback circuit 7. The setting method can be any of a method of varying the setting value V_{ref} of the reference voltage circuit 71 and a method of setting an output voltage value for the error operation circuit 72 and calculating the error considering the preset voltage value. Below will be explained how the preset voltage value V_{ref} of the reference voltage circuit 71 is changed. Although FIG. 1 assumes the output voltage value is set by the load 6 connected to the power source, it is possible to use the other circuit, a CPU, or a power controlling IC or the like that is not directly connected to the power source.

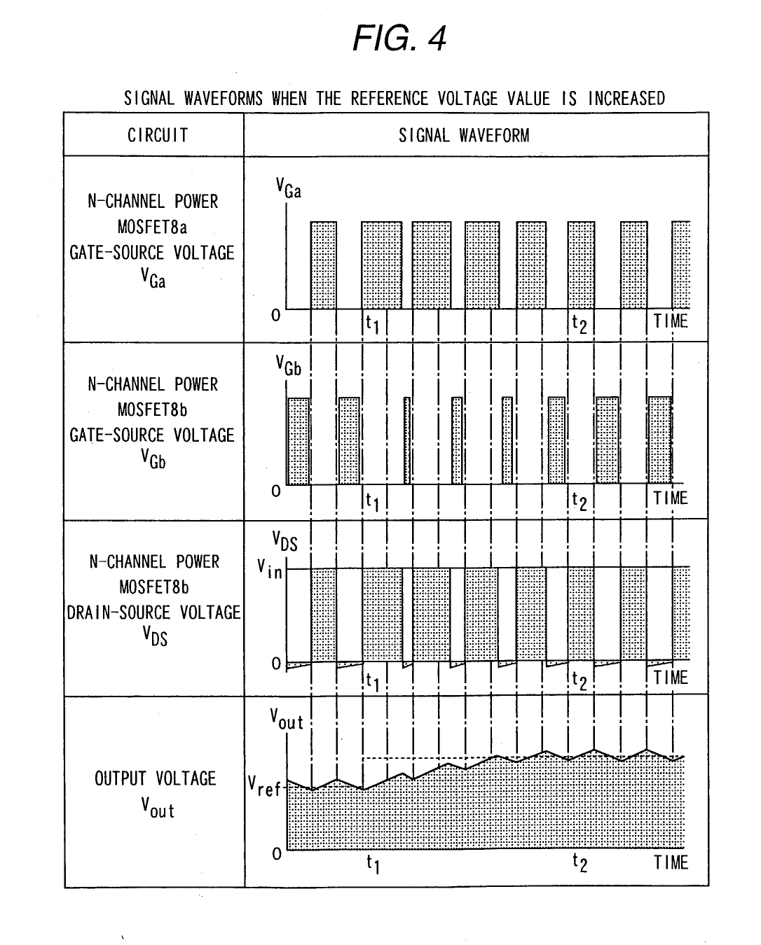

To increase the output voltage of the DC-DC converter, this embodiment increases the preset voltage value V_{ref} of the reference voltage circuit 71 over the current preset voltage value. FIG. 4 shows signal waveforms when the preset voltage value V_{ref} of the reference voltage circuit 71 is increased for a time period of t₁. After the time period t₁, the output feedback circuit 7 generates a voltage difference (error voltage), amplifies it, and outputs the amplified error voltage, as a pulse train (as already explained) to the switching control circuit 9. The fluctuation of the error voltage is reflected upon the width of output pulses by means of the comparator 92. The driving circuit 15a receives the pulse train from the comparator and applies a gate-source voltage pulses V_{Ga} (see FIG. 4) to the gate and the source of the N-channel power MOSFET 8a. FIG. 4 shows pulses which are made wider to increase the output voltage.

At the same time, the inversion circuit 16 receives the output from the comparator 92, inverts the pulse train, and outputs to the driving circuit 15b. The driving circuit 15b applies a gate-source voltage pulses V_{Gb} (see FIG. 4) to the gate and the source of the N-channel power MOSFET 8b. The pulse width of the voltage pulses V_{Gb} is shorter than that in the steady status because the pulses are inverted.

When the gate-source voltage is applied to the N-channel power MOSFET 8a, the N-channel power MOSFET 8a turns on and the N-channel power MOSFET 8b turns off. This connects the DC power source 1, the DC reactor 4, and the smoothing capacitor 5 in series. As the result, a current I_{L} flows in the DC reactor 4 and charges the smoothing capacitor 5.

When the voltage between the gate and the source of the N-channel power MOSFET 8a reaches 0, the N-channel power MOSFET 8a goes off. At the same time, N-channel power MOSFET 8b turns on to make up for it. The current I_{L} flowing in the DC reactor 4 synchronously rectified so that the current may flow from the source to the drain of the N-channel power MOSFET 8b. In this case, the voltage V_{DS} of the drain of the N-channel power MOSFET 8b is an on-voltage component of the N-channel power MOSFET 8b below 0V, that is, a negative voltage equal to the product of the ON resistance by the magnitude of the flowing current. As the result, a waveform (see FIG. 4) generates on the voltage V_{DS} between terminals of the N-channel power MOSFET 8b. The DC reactor 4 and the smoothing capacitor 5 smooth the voltage waveform V_{DS} of the N-channel power MOSFET 8b.

As the pulse width of the gate-source voltage pulses V_{Ga} is made greater, the ON time period of the N-channel power MOSFET 8a becomes greater. As the result, the charge of the smoothing capacitor 5 increases. On the contrary, the N-channel power MOSFET 8b has a voltage waveform V_{DS} as shown in FIG. 4. The voltage waveform V_{DS} of the N-channel power MOSFET 8b is smoothed by the DC reactor 4 and the smoothing capacitor 5 before being output to the load. In this case, the output voltage Vₒᵤₜ goes up. This control cycle is repeated until the output voltage Vₒᵤₜ reaches the preset voltage value V_{ref} (for a time period t₂ in FIG. 4). After this, the DC-DC converter returns to the previous steady status and works to keep the output voltage Vₒᵤₜ constant and assure the output current Iₒᵤₜ.

Next will be explained how the output voltage is decreased. It is necessary to reduce the preset voltage value V_{ref} of the reference voltage circuit 71 to decrement the output voltage of the DC-DC-converter.

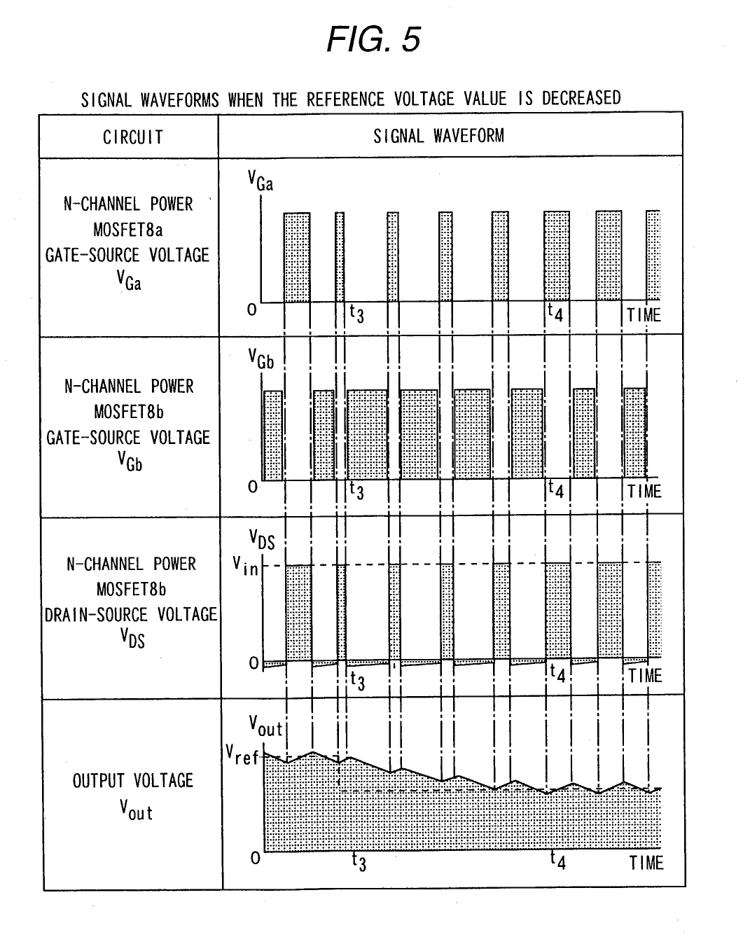

FIG. 5 shows a signal waveform when the preset voltage value V_{ref} of the reference voltage circuit 71 is decreased for a time period of t₃. After the time period t₃, the output feedback circuit 7 generates a voltage difference (error voltage), amplifies it by the error amplifier 73, and outputs it from the output feedback circuit 7. This amplified error voltage is fed into the switching control circuit 9 and output as a pulse train from the comparator as explained above. The magnitude of said error voltage is reflected upon the width of output pulses. The driving circuit 15a receives the pulse train from the comparator and applies a gate-source voltage pulses V_{Ga} (see FIG. 4) to the gate and the source of the N-channel power MOSFET 8a. In this case (when the output voltage is decreased), the pulse width of the gate-source voltage pulses V_{Ga} becomes shorter.

The output of the comparator 92 is connected to the input of the inversion circuit 16. The inversion circuit 16 receives a pulse train from the comparator 92, inverts the pulse train, and feeds it to the driving circuit 15b. The driving circuit 15b applies a gate-source voltage pulse V_{Gb} (see FIG. 5) between the gate and the source of the N-channel power MOSFET 8b. The pulse width of the voltage pulses V_{Gb} is wider than that in the steady status because the pulses are inverted.

When the gate-source voltage is applied to the N-channel power MOSFET 8a, the N-channel power MOSFET 8a turns on and the N-channel power MOSFET 8b turns off. This connects the DC power source 1, the DC reactor 4, and the smoothing capacitor 5 in series. As the result, a current I_{L} flows in the DC reactor 4 and charges the smoothing capacitor 5.

When the voltage between the gate and the source of the N-channel power MOSFET 8a reaches 0, the N-channel power MOSFET 8a goes off. At the same time, N-channel power MOSFET 8b turns on to make up for it. The current I_{L} flowing in the DC reactor 4 synchronously rectified so that the current may flow from the source to the drain of the N-channel power MOSFET 8b. In this case, the voltage V_{DS} of the drain of the N-channel power MOSFET 8b is an on-voltage component of the N-channel power MOSFET 8b below 0V, that is, a negative voltage equal to the product of the ON resistance by the magnitude of the flowing current. As the result, a waveform (see FIG. 5) generates on the voltage V_{DS} between terminals of the N-channel power MOSFET 8b. The DC reactor 4 and the smoothing capacitor 5 smooth the voltage waveform V_{DS} of the N-channel power MOSFET 8b.

As the pulse width of the gate-source voltage pulses V_{Ga} is made smaller, the ON time period of the N-channel power MOSFET 8a becomes shorter. As the result, the charge of the smoothing capacitor 5 decreases. On the contrary, the ON time period of the N-channel power MOSFET 8b becomes longer and the N-channel power MOSFET 8b has a voltage waveform V_{DS} as shown in FIG. 5. The voltage waveform V_{DS} of the N-channel power MOSFET 8b is smoothed by the DC reactor 4 and the smoothing capacitor 5 before being output to the load. In this case, the output voltage Vₒᵤₜ goes down. This control cycle is repeated until the output voltage Vₒᵤₜ reaches the preset voltage value V_{ref} (for a time period t₄ in FIG. 5). After this, the DC-DC converter returns to the previous steady status and works to keep the output voltage Vₒᵤₜ constant and assure the output current Iₒᵤₜ.

As explained above, a power supply unit capable of varying the output voltage can be accomplished by enabling the circuit to change the preset voltage value V_{ref} of the reference voltage circuit 71. However, if the smoothing capacitor 5 has a greater capacitance to suppress a ripple voltage, the following problem occurs. The problem is that it takes a lot of time to change the terminal voltage (output voltage Vₒᵤₜ) of the smoothing capacitor 5 as the capacitor 5 has a greater capacitance. This is preferable for stabilization of power source but not advantageous to a new type of CPU equipped with a power optimizing function that finely sets the supply voltages finely (several hundreds per second).

Particularly, the surplus charge stored on the smoothing capacitor 5 must be discharged to decrease the voltage. If the load 6 is heavy, the output current Iₒᵤₜ is great and the charge stored on the smoothing capacitor is dissipated as an output current and the output voltage can be rapidly decreased to the preset voltage value. However, it matters if the load is light or if no load is present. Particularly, CPUs and circuits for mobile units tend to have lighter loads. Some mobile units are equipped with a so-called standby mode which supplies power to a minimum required circuit only. In such a case, the charge on the smoothing capacitor 5 is slow to be discharged because of little output current Iₒᵤₜ and it takes a longer time period (t₄-t₃ in FIG. 5) to decrease the output voltage Vₒᵤₜ down to the preset voltage value.

Contrarily, it is necessary to charge the smoothing capacitor 5 to increase the output voltage. A capacitor of a great capacitance requires a long charging time period (t₂-t₁ in FIG. 4). We can say that the time period is dependent upon the magnitude of a current I_{L} flowing through the DC reactor 4, that is, the ability of the power source to flow a current.

Considering the above, this embodiment performs a circuit control to immediately change the output voltage to a preset voltage value even when the smoothing capacitor 5 has a large capacitance. For change of the output voltage, this embodiment has four power control modes which are selectable: Transient mode, Charge Extraction mode, Return mode, and Rectification mode. These power control modes will be explained below in sequence. The aforesaid steady status of the step-down chopper type synchronous rectification DC-DC converter is equivalent to the rectification mode. The voltage setting signal from the load 6 is also fed to the switching control circuit 9 and one of the above mode is selected for switching control according to the setting.

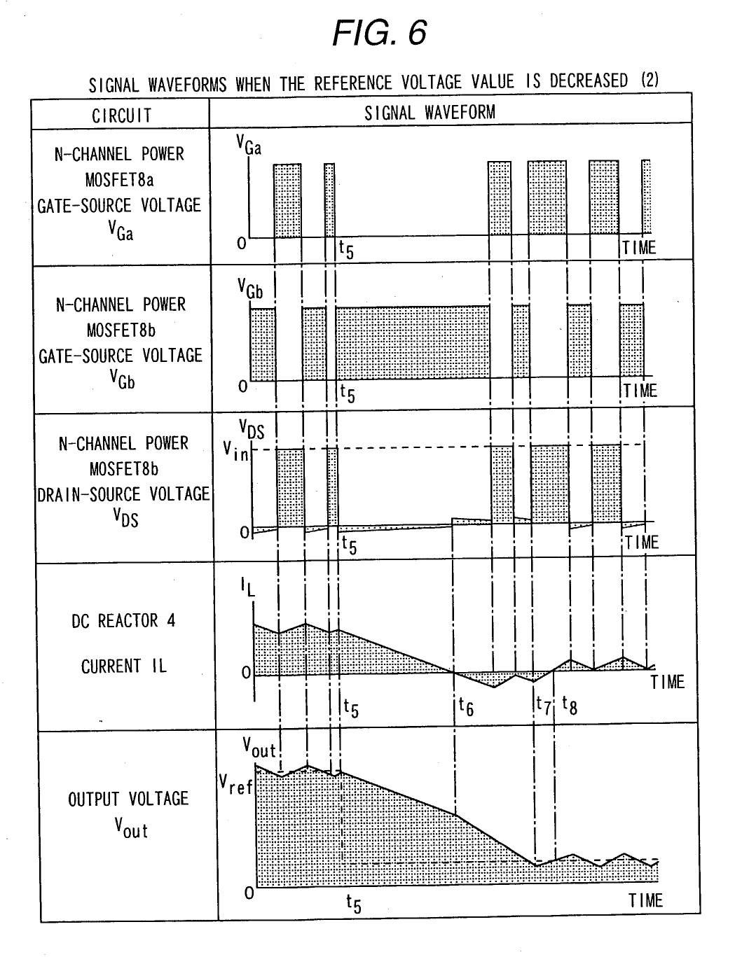

First, an operation will be explained to decrease the output voltage. The circuit control function of this embodiment enables load-independent discharging and rapid decrease of the output voltage. This mechanism is as follows: FIG. 6 shows signal waveforms indicating the circuit operation by which the preset voltage value V_{ref} of the reference voltage circuit 71 is decreased for a time period of t₅. The load is assumed to be smaller, for example, from said standby mode setting.

After the time period t₅ during which the reference voltage 71 is decreased, the power supply circuit is switched to the Transient mode. As the reference voltage 71 is decreased, the output feedback circuit 7 generates an error voltage (voltage difference). The error amplifier 73 amplifies this error voltage and outputs the amplified voltage as an output of the output feedback circuit 7. This amplified error voltage is fed to the limiter 93 in the switching control circuit 9.

Although the limiter 93 limits the maximum and minimum PWM ratios, this limitation is cancelled in the Transient mode. Therefore the amplified error voltage is directly fed to the comparator 92.

The comparator 92 compares said error voltage by the output of the triangular generating means 91 and outputs the result as a pulse train. The magnitude of said error voltage is reflected upon the pulse width of the output pulses. The driving circuit 15a receives said pulse train, outputs and implies a gate-source voltage pulses V_{Ga} (see FIG. 6) to the gate and the source of the N-channel power MOSFET 8a. The inversion circuit 16 receives a pulse train from the comparator 92, inverts the pulse train, and feeds it to the driving circuit 15b. The driving circuit 15b applies a gate-source voltage pulse V_{Gb} (see FIG. 5) between the gate and the source of the N-channel power MOSFET 8b.

As explained above, the pulse width of the voltage pulses V_{Ga} is made greater to increase the output voltage (while the pulse width of the voltage pulses V_{Gb} is decreased) or smaller to decrease the output voltage (while the pulse width of the voltage pulses V_{Gb} is increased). In this embodiment which turns off the limiter 93, pulse widths of the voltage pulses V_{Ga} and V_{Gb} are not limited. When the load is small, the smoothing capacitor 5 is slow to discharge the stored charge and as the result, the output voltage cannot be reduced immediately. Consequently, the voltage pulses V_{Gb} is applied longer to the gate and the source of the N-channel power MOSFET 8b to reduce the output voltage.

As seen from the equations (1) and (2), the current I_{L} flowing through the DC reactor 4 increases or decreases according to the on/off status of the N-channel power MOSFETs 8a and 8b. While the N-channel power MOSFET 8b is on, the current I_{L} flowing through the DC reactor 4 decreases at a rate expressed by the equation (2). As seen in FIG. 6, when the N-channel power MOSFET 8b keeps on, the current I_{L} decreases, reaches 0 (after the time t₆ in FIG. 6), and finally flows backward. This backward current I_{L} is caused by the discharge of the charge stored on the smoothing capacitor 5. Therefore, the voltage across the smoothing capacitor 5, that is, the output voltage Vₒᵤₜ goes down as the discharging advances. The current orientation discriminating circuit 10 monitors the orientation of this current I_{L}. This current orientation discriminating circuit 10 can be any as far as the orientation flowing through the DC reactor 4 can be identified.

Further, to prevent a backward current I_{L} in said DC reactor 4 which will be a loss, this embodiment rapidly discharges the charge of the smoothing capacitor 5 by this backward current independently of the magnitude of the load. It is needless to say that this control is cancelled in case the DC-DC converter detects the orientation of the flowing current and performs switching control to prevent the backward current as described, for example, in Japanese Application Patent Laid-Open Publication No. Hei 11-235022.

Although this embodiment uses the backward current I_{L} to discharge the charge of the smoothing capacitor 5, the discharged charge is singly dissipated as a loss because it is grounded through the N-channel power MOSFET 8b. To prevent this, this embodiment tries to regenerate the stored charge. The power supply circuit switches to the Charge Extraction mode when the current orientation discriminating circuit 10 detects a current I_{L} flowing backward through the DC reactor (at time t₆ in FIG. 6) and the output voltage Vₒᵤₜ is below the reference voltage 71.

In the Charge Extraction mode, this embodiment controls turning on and off the N-channel power MOSFETs 8a and 8b while keeping the backward I_{L} of the DC reactor 4. In this case, the circuit in FIG. 1 can be assumed to be a step-up chopper type DC-DC converter having the DC power source as a smoothing capacitor 5, the switching element as a N-channel power MOSFET 8b, the rectifying element as a N-channel power MOSFET 8a, and the load as a DC power supply 1. Therefore, the charge is stored as excitation energy on the DC reactor 4 while the N-channel power MOSFET 8b is on. When the N-channel power MOSFET 8a turns on, the excitation energy is emitted to the DC power source 1 through the N-channel power MOSFET 8a. If the DC power source 1 is a chargeable battery, said stored charge can be regenerated on the DC power source.

This circuit control can discharge the charge stored on the smoothing capacitor 5 and reuse it to re-charge the battery independently of the load 6. When the stored charge is discharged, the output voltage Vₒᵤₜ goes down toward the reference voltage 71 (at time t₇ in FIG. 6). When the output voltage reaches the reference voltage 71, the power supply circuit switches to the Return mode.

In the Return mode, the N-channel power MOSFET 8a keeps on (and the N-channel power MOSFET 8b keeps off) until the current I_{L} flows forward through the DC reactor 4. When the current orientation discriminating circuit 10 detects the forward current I_{L} in the DC reactor 4 (at time t₈ in FIG. 6), the power supply circuit returns to the Rectification mode, that is, the operation of the step-down chopper type DC-DC converter. From now on, the power supply circuit works to keep the output voltage Vₒᵤₜ at the preset voltage value V_{ref} of the reference voltage circuit 71.

Also when power is shut off to completely stop the load (that is, when the output voltage is 0), the DC-DC converter performs the same basic operation and circuit control. When the charge of the smoothing capacitor 5 is discharged and the output voltage becomes 0, the DC-DC converter works to keep this status.

The example in the above description of Embodiment 1 uses the discharged charge to re-charge the re-chargeable DC power supply 1. However, it is to be understood that the present invention is not intended to be limited to it. In other words, the discharged charge can be re-used as far as it can be stored.

(Embodiment 2)

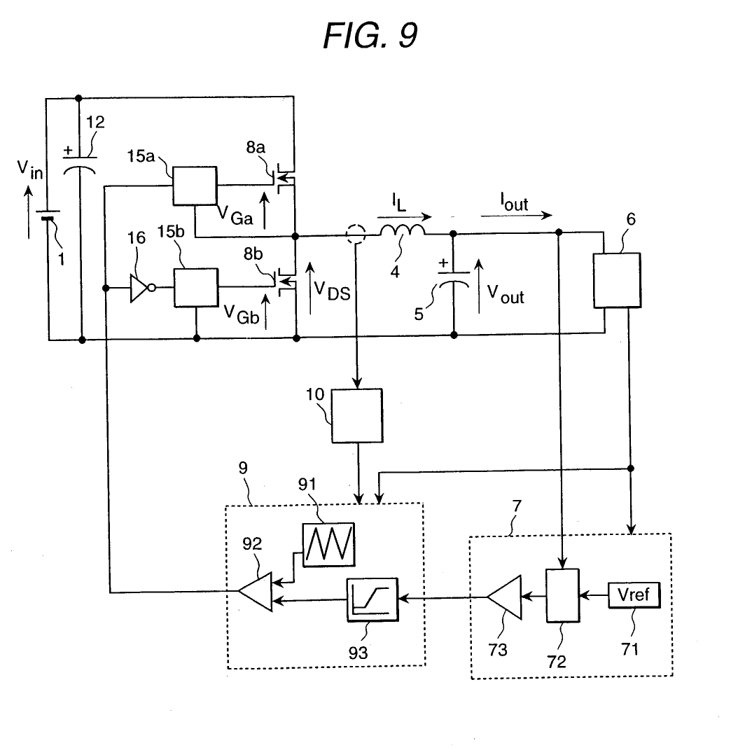

FIG. 9 is a basic configuration of a DC-DC converter which is a third embodiment of the present invention. The circuit diagram of FIG. 9 has the same circuit and components as those of FIG. 1, but FIG. 9 contains a capacitor 12 connected to both electrodes of the DC power source 1. FIG. 1 and FIG. 9 use the same symbols and numbers.

Referring to FIG. 9, the capacitor 12 enables the reuse of the charge discharged on the smoothing capacitor 5 even when the DC power source 1 is not a rechargeable battery. This circuit control is the same as that of Embodiment 1 and its explanation is omitted here. In Embodiment 2, the DC power source 1 need not be re-chargeable because the capacitor 12 can store the discharged charge. The charge on the capacitor 12 is discharged in the steady status or to increase the output voltage, sent to the smoothing capacitor 5 through the DC reactor 4, and stored there. The capacitor 12 in Embodiment 2 can be substituted by any means as far as the means can store a charge.

(Embodiment 3)

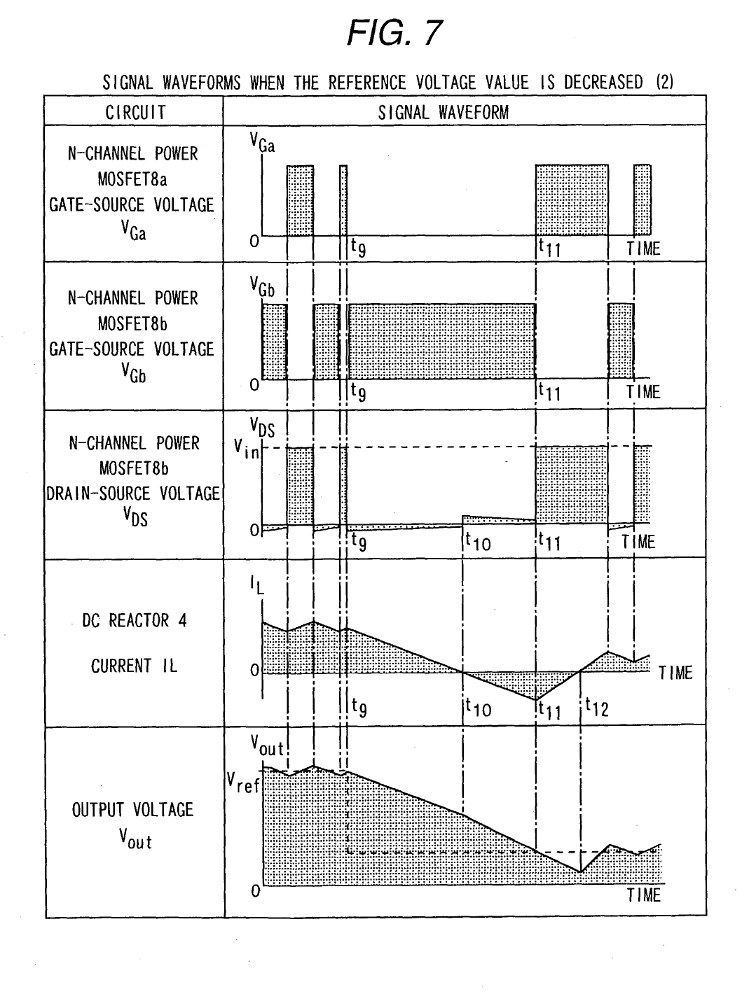

Although Embodiment 1 uses four power control modes to decrease the output voltage, the Charge Extraction mode is not required unless the stored charge is reused. Embodiment 3 does not use the Charge Extraction mode of Embodiment 1. FIG. 7 shows signal waveforms indicating its circuit operation. When the reference voltage 71 goes down (at time t₉ in FIG. 7), the power supply circuit is switched to the Transient mode. The Transient mode cancels the limitation of the limiter 93 as explained above to unlimit the pulse width of pulses output from the switching control circuit. Further, if the DC-DC converter has a control means to prevent the current in the DC reactor to flow backward, the Transient mode also cancels the control.

As explained above, the pulse width of the voltage pulses V_{Ga} is made greater to increase the output voltage (while the pulse width of the voltage pulses V_{Gb} is decreased) or smaller to decrease the output voltage (while the pulse width of the voltage pulses V_{Gb} is increased). In this embodiment which turns off the limiter 93, pulse widths of the voltage pulses V_{Ga} and V_{Gb} are not limited. When the load is small, the smoothing capacitor 5 is slow to discharge the stored charge and as the result, the output voltage cannot be reduced immediately. Consequently, the voltage pulses V_{Gb} is applied longer to the gate and the source of the N-channel power MOSFET 8b to reduce the output voltage.

As seen from the equations (1) and (2), the current I_{L} flowing through the DC reactor 4 increases or decreases according to the on/off status of the N-channel power MOSFETs 8a and 8b. While the N-channel power MOSFET 8b is on, the current I_{L} flowing through the DC reactor 4 decreases at a rate expressed by the equation (2). As seen in FIG. 7, when the N-channel power MOSFET 8b keeps on, the current I_{L} decreases, reaches 0 (after the time t₁₀ in FIG. 7), and finally flows backward. This backward current I_{L} is caused by the discharge of the charge stored on the smoothing capacitor 5. Therefore, the voltage across the smoothing capacitor 5, that is, the output voltage Vₒᵤₜ goes down as the discharging advances. In this case, the Transient mode is retained even when the current direction changes. The charge flows into the ground through the N-channel power MOSFET 8b and dissipates as a loss.

When the output voltage reaches the reference voltage 71 (at time t₁₁ in FIG. 7) by discharge of the stored charge, the power supply circuit is switched to the Return mode. In the Return mode, the N-channel power MOSFET 8a is kept on until the current I_{L} of the DC reactor 4 starts to flow forward. When the current orientation discriminating circuit 10 detects a current I_{L} flowing forward through the DC reactor (at time t₁₂ in FIG. 7), the power supply circuit switches to the Rectification mode, that is, the operation of the step-down chopper type DC-DC converter and works to keep the output voltage Vₒᵤₜ at a preset voltage value V_{ref} of the reference voltage circuit 71. This method can rapidly bring the output voltage to the preset value as it can discharge the stored charge on the smoothing capacitor 5 independently of the load. When power is shut off to completely stop the load (that is, when the output voltage is 0), this embodiment performs the same basic operation and circuit control. When the charge of the smoothing capacitor 5 is discharged and the output voltage becomes 0, the DC-DC converter works to keep this status. In this circuit controlling method, the discharged charge is dissipated as a loss.

In the above description, the Transient mode cancels the limitation of the limiter 93. However this embodiment is not intended to be limited to it. The above circuit operation can be accomplished with the limiter 93 enabled. However in this case, the current is periodically sent from the DC power source 1 to the DC reactor 4 for storage. Said backward current flows only when the DC reactor 4 has no charge. Therefore, this control method is hard to discharge the stored charge and takes a longer time to set the output voltage than the method which cancels the limitation of the limiter 93.

Next will be explained a circuit operation to increase the output voltage. The time required to increase the output voltage is dependent upon the time required to charge the smoothing capacitor 5. This time is dependent upon the magnitude of the current I_{L} passing through the DC reactor 4, that is, an ability of the DC power source 1 to flow the current. Therefore, when the DC power source has a driving function, it is possible to shorten the time (t₂-t₁ in FIG. 4) to increase the voltage.

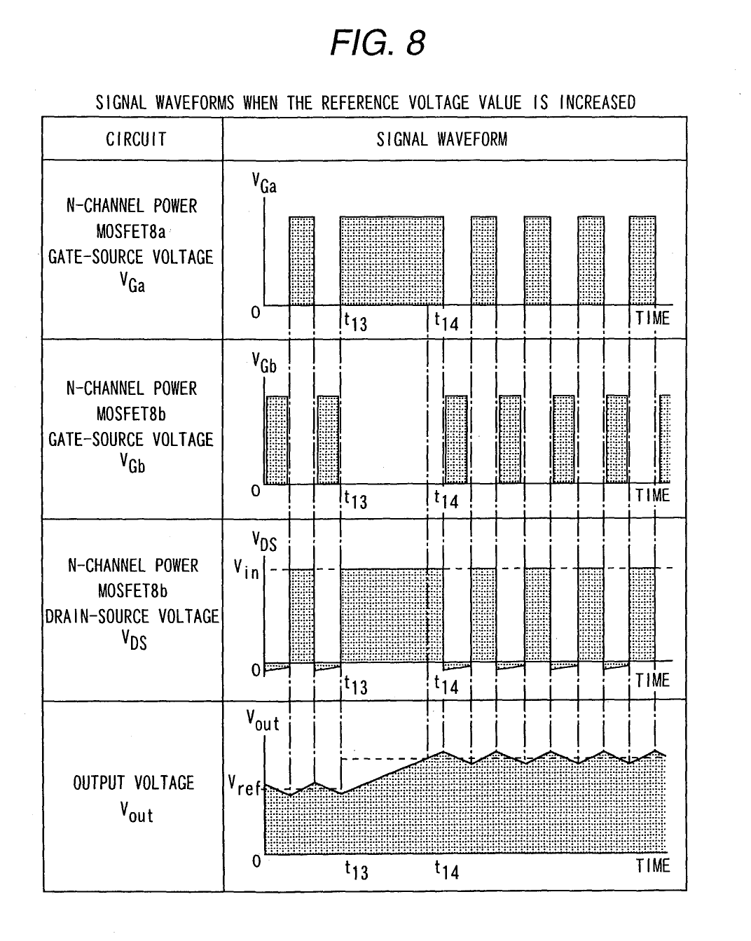

Further, it is possible to rapidly increase the output voltage Vₒᵤₜ to the reference voltage 71. FIG. 8 shows signal waveforms indicating its circuit operation. To increase the output voltage, the smoothing capacitor 5 must be charged as explained above. In the circuit of FIG. 1, the smoothing capacitor 5 can be charged only while the N-channel power MOSFET 8a is on. So also when the reference voltage 71 is increased (at t₁₃ in FIG. 8), the power supply circuit is set to the Transient mode. In the Transient mode, the limitation of the limiter 93 in the switching control circuit is turned off as explained above. Accordingly, the limitation on the pulse width of a pulse train output from the switching control circuit is cancelled. Therefore, the time becomes longer to apply the voltage pulses V_{Ga} to the gate and the source of the N-channel power MOSFET 8a. This keeps on charging the smoothing capacitor 5 and accelerates increase of the output voltage to the reference voltage (faster than the control shown in FIG. 4). When the output voltage reaches the reference voltage (at time t₁₄ in FIG. 14), the power supply circuit is switched to the Rectification mode. The DC-DC converter returns to the operation of the normal step-down chopper type DC-DC converter and keeps the output voltage at the preset value V_{ref} of the reference voltage circuit 71.

In the above description, the Transient mode cancels the limitation of the limiter 93. However this embodiment is not intended to be limited to it. The above circuit operation can be accomplished with the limiter 93 enabled. However in this case, the current is periodically sent from the DC power source 1 to the DC reactor 4 for storage. During this time period, the smoothing capacitor 5 is not charged by the DC power source 1. Therefore, it takes a longer time to charge the smoothing capacitor 5 than the time when the limitation of the limiter 93 is cancelled and consequently it take a longer time to set the output voltage.

The aforesaid examples control switching of the N-channel power MOSFETs 8a and 8b of FIG. 1 to discharge and charge the smoothing capacitor 5 and change the output voltage.

(Embodiment 4)

The step-down chopper type DC-DC converter of FIG. 2 which is one of prior arts uses a feedback diode 3 for the N-channel power MOSFET 8b of FIG. 1. The feedback diode cannot perform switching control. In this circuit configuration, a current flows through the feedback diode 3 when the excited energy is discharged to the DC reactor 4 or when a feedback is made. However, a current cannot be flow backward in the DC reactor 4 and the charge on the smoothing capacitor 5 cannot be discharged. In such a case, a circuit is added to discharge the charge of the smoothing capacitor 5. Below will be explained the circuit operation and control of Embodiment 4 having a discharging circuit.

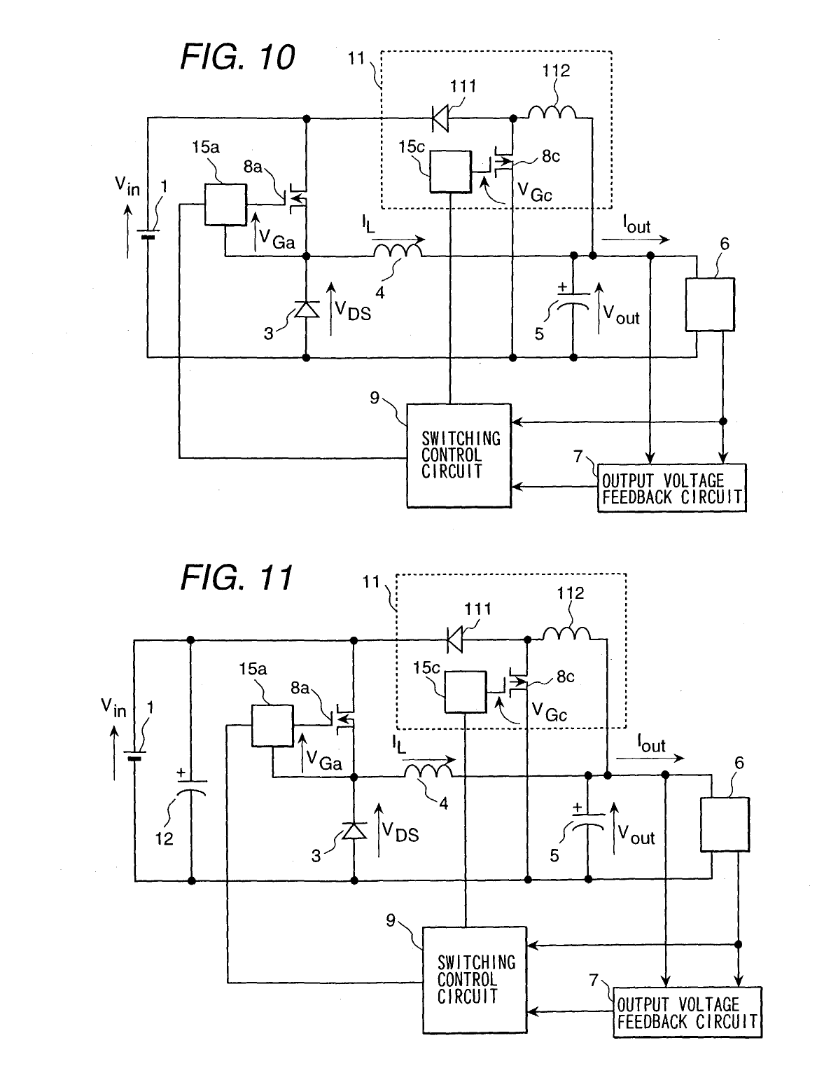

FIG. 10 shows a basic configuration of a DC-DC converter which is a fourth embodiment of the present invention. The DC-DC converter of FIG. 10 comprises the step-down chopper type DC-DC converter of FIG. 2 and a circuit 11 for discharging the charge of the smoothing capacitor 5. The circuit diagram of FIG. 10 has the same circuit and components as those of FIG. 1 and FIG. 2 and uses the same symbols and numbers. The discharging circuit 11 for discharging the charge of the smoothing capacitor 5 comprises, for example, a diode 111, a DC reactor 112, a N-channel power MOSFET 8c, and a driving circuit 15c. The smoothing capacitor 5 is a low-impedance large-capacitance capacitor such as a representative electric double layer capacitor.

In FIG. 10, the anode of the DC power source 1 connected to the drain of the N-channel power MOSFET 8a and the source of the N-channel power MOSFET 8a is connected to one terminal of the DC reactor 4 and the cathode of the feedback diode 3. The other terminal of the DC reactor 4 is connected to the anode of the smoothing capacitor 5. The cathode of the smoothing capacitor 5, the anode of the feedback diode 3, and the cathode of the DC power source are connected together. A load 6 is connected to both ends of the smoothing capacitor 5.

The anode of the smoothing capacitor 5, that is the output of the smoothing capacitor 5 is connected to the output voltage feedback circuit 7. The output voltage feedback circuit 7 compares the output voltage by the reference voltage of the output voltage feedback circuit 7 and outputs an error (voltage difference) signal. This error signal is fed to the switching control circuit 9, converted into, for example, a PWM control signal, and output to the driving circuit 15a. The output of the driving circuit 15 is connected the gate of the N-channel power MOSFET 8a.

The anode of the smoothing capacitor 5 is connected to the DC reactor 112 in the discharging circuit 11. The other end of the DC reactor 112 (which is not connected to the smoothing capacitor 5) is connected to the anode of the diode 111 and to the drain of the N-channel power MOSFET 8c. The source of the N-channel power MOSFET 8c is connected to the cathode of the smoothing capacitor 5. The driving circuit 15 receives a control signal from the switching control circuit 9 and outputs the gate-source voltage pulses VGc. These pulses are applied to the gate and the source of the N-channel power MOSFET 8c. The cathode of the diode 111 is connected as the output of the discharging circuit to the DC power source 1.

As explained above, the DC-DC converter of FIG. 10 comprises the step-down chopper type DC-DC converter and a discharging circuit 11. In the steady status, this circuit disables the discharging circuit 11 and works as a step-down chopper type DC-DC converter to keep the output voltage Vₒᵤₜ constant. In this case (while the discharging circuit 11 is disabled), the N-channel power MOSFET 8c is turned off. The step-down chopper type DC-DC converter works in the same manner as the prior arts and its explanation is omitted.

Next will be explained how the output voltage is increased. It is necessary to charge the smoothing capacitor 5 to increase the output voltage. In the circuit of FIG. 10, the smoothing capacitor 5 can be charged only when the N-channel power MOSFET 8a is on. Therefore, also in this case, the DC-DC converter performs the same circuit control as that of the embodiment of FIG. 1 with the discharging circuit turned off. In this case, the control of the N-channel power MOSFET 8a is the same as the aforesaid circuit control and the explanation is omitted.

Next will be explained how the output voltage is decreased. In the circuit of FIG. 10, the feedback diode 3 prevents a current from flowing backward through the DC reactor 4 as in Embodiment 1. If the load 6 is small, the stored charge cannot be discharged and the output voltage is hard to be decreased directly. So the discharging circuit is used to discharge the stored charge. Below will be explained the operation of the circuit. To decrease the output voltage, the N-channel power MOSFET 8a is turned off and the N-channel power MOSFET 8c of the discharging circuit 8c is turned on. At this time point, the energy excited by the DC reactor 4 is sent to the DC reactor 112 of the discharging circuit 11 and finally the smoothing capacitor 5 starts to discharge the stored charge. With this, even when the load 6 is small, the stored charge on the smoothing capacitor 5 can be discharged and the output voltage can be decreased. However, if the N-channel power MOSFET 8c is kept on, the discharged charge is grounded through the N-channel power MOSFET 8c and dissipated as a loss. So, this embodiment also re-uses the discharged charge. By turning on and off the N-channel power MOSFET 8c, the discharging circuit 11 was made to work as a step-up chopper type DC-DC converter. In this case, this embodiment of FIG. 10 can assume the DC power source as a smoothing capacitor 5, the switching element as a N-channel power MOSFET 8c, the rectifying element as a diode 111, and the load as a DC power source 1. Accordingly, the stored charge is stored as excitation energy on the DC reactor 112 while the N-channel power MOSFET 8c is on. When the N-channel power MOSFET 8c turns off, the excitation energy is sent to the DC power source 1 through the diode 111. If the DC power source 1 is a re-chargeable battery, the above stored charge can be re-generated on the DC power source 1.

The circuit controlling of said discharging circuit 11 discharges the charge on the smoothing capacitor 5 independently of the load 6 and re-generates the discharged charge on the DC power source 1. The output voltage Vₒᵤₜ decreases when the stored charge is discharged. When the output voltage reaches the preset voltage value, the N-channel power MOSFET 8c is turned off and the discharging circuit 11 stops. Then the DC-DC converter returns to the operation of the step-down chopper type DC-DC converter. From this time on, the power supply circuit works to keep the output value Vₒᵤₜ at a preset voltage value.

(Embodiment 5)

As shown in FIG. 11, this embodiment has a charge storing means, for example, a capacitor connected between electrodes of the DC power source 1 of Embodiment 4. This capacitor 12 can regenerate the charge which is stored and discharged by the smoothing capacitor 5 even when the DC power source 1 is not a rechargeable battery. The other circuit configuration and operation are the same as those of Embodiment 3.

As described above for each of the embodiments, the circuit configuration and controlling method in accordance with the present invention enables the smoothing capacitor 5 to discharge independently of the load and thus can set the output voltage to a preset voltage value rapidly. Further, the circuit controlling method of the present invention can regenerate the discharged charge on a chargeable battery or the like.

The present invention can provide a power supply unit using a large-capacitance capacitor of low ripple voltages which can quickly change its output voltage independently of a load. Further, the circuit control method of the present invention can regenerate the charge stored on the smoothing capacitor 5 and expects high energy efficiency. This method uses less components of the power supply unit than the method of using a plurality of regulators connected in parallel and can make the power supply unit more compact.

What is claimed is:

1. In a DC-DC converter for smoothing an input from a direct current (DC) power source and for supplying a preset output voltage to a load, the DC-DC converter comprising:
said direct current (DC) power source;
a first charge storage means for smoothing an output;
a first reactor for connecting said direct current (DC) power source and said first charge storage means in series;
a first switching element provided between said first reactor and one end of said direct current (DC) power source; and
a second switching element in which one end of said second switching element is connected between said first reactor and said first switching element.

2. A DC-DC converter according to claim 1, wherein a power conversion means includes:
said first reactor for connecting said direct current (DC) power source and said first charge storage means in series;
said first switching element provided between said first reactor and one end of said direct current (DC) power source; and
said second switching element in which one end of said second switching element is connected between said first reactor and said first switching element, wherein
said power conversion means performs a power conversion using an excitation energy which is caused by a control of said first switching element and said second switching element;
in a steady state, a power is sent to a direction of said first charge storage means from said direct current (DC) power source;
in a time period during an output voltage is increased to a present value, said power is sent to said direction of said first charge storage means from said direct current (DC) power source; and
in a time period during said output voltage is decreased to another present value, said power is sent to a direction of said direct current (DC) power source from said first charge storage means.

3. A method of controlling a DC-DC converter for smoothing an input from a direct current (DC) power source and for supplying output a preset output voltage to an integrated circuit, wherein the DC-DC converter comprises:
a first reactor provided between an input of said direct current (DC) power source and said integrated circuit; and
a first charge storage means connected in parallel between said first reactor and said integrated circuit;
the method of controlling the DC-DC converter comprising the acts of:
in a steady state where a preset output voltage is supplied to said integrated circuit, flowing a forward direction current from a side of said direct current (DC) power source of said first reactor to a side of said integrated circuit of said first reactor;
in a transitional time period during said output voltage is increased to another voltage, flowing a forward direction current from said side of said direct current (DC) power source of said first reactor to said side of said integrated circuit of said first reactor to charge said first charge storage means and to increase said output voltage; and
in a transitional time period during the output voltage is further decreased to another preset value, flowing a backward direction current from said side of said integrated circuit of said first reactor to said side of said direct current (DC) power source of said first reactor to discharge the storage charge on said first charge storage means and to decrease said output voltage.
